(19) United States
(12) Patent Application Publication
(10) Pub. No.: US 2010/0040090 A1
(43) Pub. Date: Feb. 18, 2010

(54) SYNCHRONIZATION METHOD FOR ALLOWING FIXED TIME DELAY AND BRIDGE EMPLOYING THE SAME

(75) Inventors: Seung Woo LEE, Daejeon-city (KR); Hyun Yong HWANG, Daejeon-city (KR); Dae Geun PARK, Daejeon-city (KR); Bhum cheol LEE, Daejeon-city (KR)

Correspondence Address: Muncy, Geissler, Olds & Lowe, PLLC, P.O. BOX 1364, FAIRFAX, VA, 22038-1364, US

(73) Assignee: Electronics and Telectcommunicatios Research Institte, Daejeon-city (KR)

(21) Appl. No.: 12/389,944

(22) Filed: Feb. 20, 2009

(30) Foreign Application Priority Data
Aug. 14, 2008 (KR) 10-2008-0079926

(51) Int. Cl. H04J 3/06

(52) U.S. Cl. 370/503

(57) ABSTRACT

Provided are a time synchronization method allowing a fixed time delay and a bridge that is interposed between a master and a slave, according to the method. In the bridge, a predetermined time after the synchronization packet is set as an output time of the synchronization packet and the synchronization packet is output at the output time. Accordingly, it is possible to delay synchronization packets in the bridge for the same time, thereby increasing the time synchronization precision.

### CROSS-REFERENCE TO RELATED PATENT APPLICATION

This application claims the benefit of Korean Patent Application No. 10-2008-0079926, filed on Aug. 14, 2008, in the Korean Intellectual Property Office, the disclosure of which is incorporated herein in its entirety by reference.

### BACKGROUND OF THE INVENTION

1. Field of the Invention

The present invention relates to a synchronization method in a network, and more particularly, to a network synchronization method for allowing a fixed time delay.

The present invention is derived from a research project supported by the Information Technology (IT) Research & Development (R&D) program of the Ministry of Information and Communication (MIC) and the Institute for Information Technology Advancement (IITA) [2007-S-102-02, Development of Multimedia Convergence Network On-chip Technique].

2. Description of the Related Art

In general, systems that are distributed in a packet exchange network need a protocol for time synchronization. A system that provides a reference time for time synchronization is set as a master, other systems are set as slaves, and each of the slaves exchange a message or synchronization signal containing time information with the master, thereby enabling time synchronization between each of the slaves and the master.

A network time protocol (NTP) is a method which has been often employed in local area networks (LANs) and wide area networks (WANs), among conventional protocols for time synchronization between a master and a slave connected in a network. The NTP synchronizes a plurality of computers connected via a network with each other by using coordinated universal time (UTC) and thus does not need additional hardware. For this reason, the NTP is inexpensive and has a synchronization precision ranging from several msecs to several tens of msecs, in an Internet-based environment.

However, Ethernet-based packet exchange networks have replaced circuit switching networks, and a time synchronization protocol, the precision of which is higher than the NTP, is needed for a real-time streaming service. To this end, the Institute of Electrical and Electronic Engineers (IEEE) has developed a precision time protocol (PTP) and provided standards thereof.

FIG. 1 is a diagram illustrating an example of a conventional time synchronization method using the PTP. Referring to FIG. 1, similar to the NTP, according to the PTP, a master and a slave exchange time information and a message related to the time information with each other in order to determine the offset between the master's clock and the slave's clock and a propagation time delay that occurs when transmitting a message via a network, and then the slave's clock is synchronized with the master's clock.

First, in order to determine the offset, the master periodically transmits a synchronization message SYNC to the slave. In this case, the master measures a time value t1 when it transmits a time synchronization signal, and transmits to the slave the synchronization message SYNC containing the time value t1.

The slave measures a time value t2 when it receives the synchronization message SYNC. Then the slave calculates the offset by using both the time value t1 contained in the synchronization message SYNC transmitted from the master and the time value t2 measured when receiving the synchronization message SYNC.

However, while the synchronization message SYNC is transmitted from the master to the slave, a propagation time delay occurs and thus needs to be calculated. To measure the propagation time delay in the network, the slave transmits a time delay request signal REQ to the master and measures a time value t3 when it transmits the time delay request signal REQ. The master measures a time value t4 when it receives the time delay request signal REQ, and transmits a response message RESP containing the time value t4 to the slave.

Thus the slave has each of the time value t1 received via the synchronization message SYNC, the time value t2 measured when the synchronization message SYNC is received, the time value t3 when the time delay request signal REQ is transmitted, and the time value t4 measured when the master receives the time delay request signal REQ. Accordingly, the offset and the propagation time delay are calculated using the four time values t1 through t4, as follows:

D+0=t2−t1

D−0=t4−t3

D=((t2−t1)+(t4−t3))/2

O=((t2−t1)−(t4−t3))/2 (1),

wherein O denotes the offset and D denotes the propagation time delay. It is assumed that a propagation time delay occurring when the master transmits a message to the slave is equal to a propagation time delay occurring when the slave transmits a message to the master.

FIG. 2 is a diagram illustrating a conventional method of applying time synchronization using the PTP to a network including multi-stage bridges. Referring to FIG. 2, in order to perform time synchronization between a master and a slave by using the PTP, a first bridge 1 is time-synchronized with the master, a second bridge 2 is time-synchronized with the first bridge, and such a process is repeated until the slave is time-synchronized with an n^{th} bridge N. Thus the more bridges (a total of N bridges in FIG. 2), the more errors in the offset and the propagation time delay accumulate due to deviation of a message delivery time and jitter.

To solve this problem, a slave that is to be time-synchronized with the master is determined, each of bridges and links between the slave and the master measures a time delay upon receipt of a synchronization message, and an overall time delay value in the network is delivered to the slave, thereby reducing the accumulated errors. The overall time delay value in the network is the sum of time delays occurring between the bridges and the links connecting the master and the slave, and is calculated as follows:

$${D}_{TOTAL} = {\sum }_{i = 0}^{N} L ( i ) + {\sum }_{i = 1}^{N} B ( i ) , \qquad ( 2 )$$

wherein D_{TOTAL} denotes the overall time delay in the network including the bridges and the links, L(i) denotes a time delay caused by an i^{th} link, and B(i) denotes a time delay caused by an i^{th} bridge.

The precision of the time synchronization using the PTP relates to the error between the offset calculated by the slave and a time delay.

In such a conventional time synchronization method using the PTP, a master periodically transmits a time synchronization signal to a slave via a bridge, and then, the slave extracts information regarding an overall time delay in a network from the time synchronization signal and adjusts time information of the slave itself, thereby enabling time synchronization between the master and the slave. However, in the case of time delays caused in the multi-stage bridges, the amounts of time needed to process the synchronization signal in the bridges are different from one another. Thus even if the master periodically transmits the synchronization signal, the periodicity of the synchronization signal is lost while passing through the multi-stage bridges. Different time delays caused by the respective bridges cause jitter to occur in the synchronization signal finally delivered to the slave, thereby degrading the time precision of the synchronization signal which is required to have periodicity so as to synchronize the slave with the master.

### SUMMARY OF THE INVENTION

The present invention provides a method of improving time synchronization precision by fixing the amount of a time delay that occurs between a master and a slave.

According to an aspect of the present invention, there is provided a time synchronization method performed in at least one bridge interposed between a master and a slave, the method including setting an output time of a synchronization packet to a predetermined time after the synchronization packet is received; and outputting the synchronization packet at the set output time.

According to another aspect of the present invention, there is provided a time synchronization method performed in at least one bridge interposed between a master and a slave, the method including categorizing received packets into a synchronization packet and general data packets; storing the synchronization packet in a high-priority region of a time slot corresponding to a receipt cycle of the synchronization packet from among time slots of a scheduler; setting an output time of the synchronization packet to a predetermined time after the synchronization packet is received; and outputting the synchronization packet stored in the corresponding time slot of the scheduler, at the set output time.

According to another aspect of the present invention, there is provided a bridge located between a master and a slave to perform time synchronization, the bridge including a packet categorizing unit categorizing received packets into a synchronization packet and general data packets; a switching unit storing the synchronization packet in a high-priority region of a time slot corresponding to a receipt cycle of the synchronization packet from among time slots of a scheduler; a synchronization unit setting an output time of the synchronization packet to a predetermined time after the synchronization packet is received; and a scheduler outputting the synchronization packet stored in the corresponding time slot of the scheduler, at the set output time.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an example of a conventional time synchronization method using a precision time protocol (PTP);

FIG. 2 is a diagram illustrating a conventional method of applying time synchronization using the PTP to a network including multi-stage bridges;

FIG. 3 is a flowchart illustrating a time synchronization method performed by a master according to an embodiment of the present invention;

FIG. 4 is a diagram illustrating times when a synchronization packet is input and output for time synchronization, according to an embodiment of the present invention;

FIG. 5 is a diagram schematically illustrating a network to which a time synchronization method according to an embodiment of the present invention is applied;

FIG. 6 is a block diagram of a switch for time synchronization according to an embodiment of the present invention;

FIG. 7 is a diagram illustrating a process of receiving a packet via a switch according to a time synchronization method according to an embodiment of the present invention;

FIG. 8 is a diagram illustrating a process of processing a synchronization packet by using a switch employing a time synchronization method according to an embodiment of the present invention; and

FIG. 9 is a diagram illustrating a process of outputting a packet from a switch according to a time synchronization method according to an embodiment of the present invention.

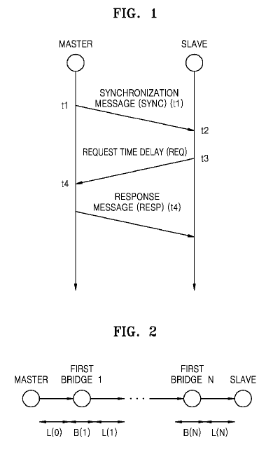

### DETAILED DESCRIPTION OF THE INVENTION

A time synchronization method for allowing a fixed time delay according to exemplary embodiments of the present invention will now be described in detail with reference to the attached drawings.

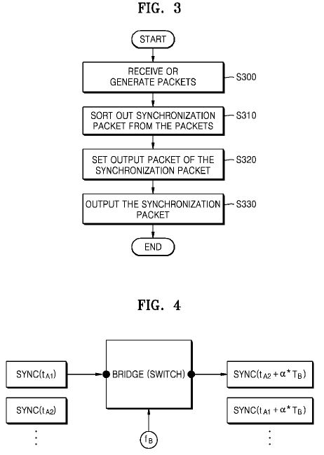

FIG. 3 is a flowchart illustrating a time synchronization method performed by a master according to an embodiment of the present invention. Referring to FIG. 3, the master generates a synchronization packet, and a bridge located between the master and a slave receives the synchronization packet from the master or a preceding bridge (operation S300). It is preferable that the synchronization packet is differentiated from general data packets. For example, if the synchronization packet is an Ethernet packet, the master generates it to include an indication having a predetermined format in a payload thereof so that the packet may be differentiated from a general data packet. The master periodically outputs the generated synchronization packet. The synchronization packet may be differentiated from a general data packet in various conventional ways, and thus, a detailed description thereof will not be provided.

If receiving packets from the master or the preceding bridge, the bridge classifies the synchronization packets out from among the packets (operation S310). Then the bridge determines output times of the respective synchronization packets so that it may retain the synchronization packets for a predetermined time and then output them (operation S320). In detail, the bridge allocates a higher priority to the synchronization packets than to general data packets so that they may be output before the general data packets, at the output times (operation S330).

Thus the bridge sets the output times of the synchronization packets to a predetermined time after they are received, and respectively outputs the synchronization packets at the corresponding output times, thus outputting the synchronization packets that are received periodically without damaging the periodicity thereof.

FIG. 4 is a diagram illustrating times when synchronization packets are respectively input and output for time synchronization, according to an embodiment of the present invention. Referring to FIG. 4, a bridge sequentially receives the synchronization packets. The synchronization packets are received periodically but sometimes may not be received periodically so the bridge delays all the synchronization packets for the same time so that the synchronization packets may be output at time intervals at which the synchronization packets are received.

More specifically, when receiving a first synchronization packet SYNC(t_{A1}) and a second synchronization packet SYNC(t_{A2}), the bridge checks, from the synchronization packets, information regarding times (tₐ₁,tₐ₂) when the synchronization packets are respectively transmitted, and then checks times (t_{B1}, t_{B2}) when the synchronization packets are respectively received. Next, the bridge calculates a frequency transformation value α from the times (t_{A1}, t_{A2}) and the times (t_{B1}, t_{B2}) by using an equation, α=[(t_{A1}−t_{A2})/(t_{A1}−t_{A2})]. A time T_{B}′ during which each of the synchronization signals is retained in the bridge, i.e., a time delayed in the bridge, is calculated to be α×T_{B} by multiplying the frequency transformation value α by a time T_{B} of a clock signal operating at an operating frequency f_{B} of the bridge. Thus the bridge sets output time of each of the synchronization packets by combining time Tᵢₙ when the synchronization packet is input with a time T_{B}′ during which the synchronization signal is delayed in the bridge.

The bridge respectively outputs the synchronization packets at the output times, and each of the output synchronization packets contains information regarding the output time, i.e., a time value (Tᵢₙ+T_{B}′). For example, referring to FIG. 4, a first output synchronization packet contains a time value (t_{A1}+α×T_{B}) and a second output synchronization packet contains a time value (t_{A2}+α×T_{B}).

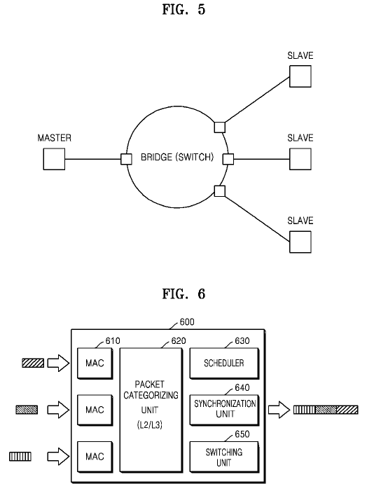

FIG. 5 is a diagram schematically illustrating a network to which a time synchronization method according to an embodiment of the present invention is applied. Referring to FIG. 5, the network largely includes a master node, bridges (or switches), and slave nodes in terms of time synchronization. The master node periodically transmits a synchronization packet containing time information of the master node to the slave nodes via the bridges (or switches). Each of the slave nodes extracts time information of the master node and the bridges (switches) from the synchronization packet and adjusts the time of the slave node itself to be synchronized with the master node.

FIG. 6 is a block diagram of a switch 600 for time synchronization according to an embodiment of the present invention. Referring to FIG. 6, the switch 600 includes a media access control (MAC) unit 610, a packet categorizing (L2/L3 function) unit 620, a scheduler 630, a synchronization unit 640, and a switching unit 650.

The MAC unit 610 performs statistical collection and packet error detection by categorizing received packets.

The packet categorizing (L2/L3 function) unit 620 performs an L2 lookup or L3 forwarding operation by using header information of the received packets, and determines output ports via which the packets are respectively output. Also, the packet categorizing (L2/L3 function) unit 620 analyzes the received packets to sort out a synchronization packet from among the received packets.

The switching unit 650 stores the received packets via a shared buffer (not shown).

The scheduler 630 respectively outputs the switched packets at output times via the corresponding output ports.

For example, if the scheduler 630 is a calendar queue scheduler, the synchronization packet is assigned to a high-priority region of a time slot, which corresponds to a cycle T of a synchronization packet. Accordingly, since the synchronization packet is assigned to a high-priority queue of the calendar queue scheduler, the synchronization packet may be transmitted exactly on time since it is first transmitted from among a plurality of packets that are to be transmitted in the same time slot.

The calendar queue scheduler consists of a plurality of time slots each having several memories for storing packets. The calendar queue scheduler is capable of transmitting the packets at predetermined points of time and sequentially outputting them according to a predetermined priority.

The synchronization unit 640 receives a local clock to determine the output time of the calendar queue scheduler, transforms the local clock into a time value, and delivers the time value to the calendar queue scheduler.

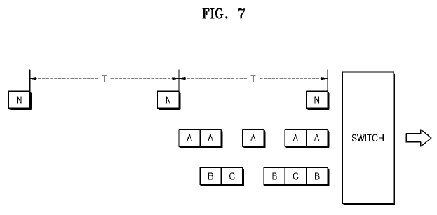

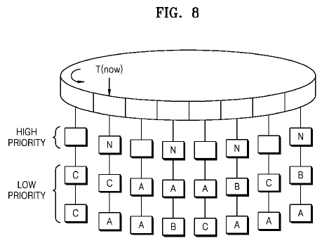

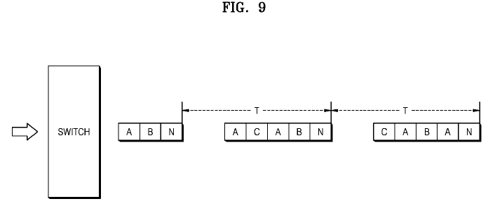

FIG. 7 is a diagram illustrating a process of receiving a packet via a switch according to the time synchronization method according to an embodiment of the present invention. FIG. 8 is a diagram illustrating a process of processing the synchronization packet by using the switch employing the time synchronization method according to an embodiment of the present invention. FIG. 9 is a diagram illustrating a process of outputting the packet from the switch according to the time synchronization method according to an embodiment of the present invention.

Referring to FIG. 7, it is assumed that one port of the switch is set to transmit synchronization packets and the other two ports of the switch are set to receive general data packets. Also, it is assumed that the switch has only one output port. Also, it is assumed that a synchronization packet N is received at regular time intervals T and general data packets A, B, and C are received at irregular time intervals, and the synchronization packet N has priority over the general data packets if they are to be received at same time.

Referring to FIG. 8, a high priority is assigned to the received synchronization packet N, a lesser priority is assigned to the general data packets A, B, and C according to the order in which they are received, and then all the packets are stored in time slots of a calendar queue scheduler. Referring to FIG. 8, it is assumed for convenience of explanation that the calendar queue scheduler consists of eight time slots each having three packet memories for three respective packets. Also, it is assumed that the sizes of the synchronization packet N and the general data packets are the same and only one packet is stored in each of the packet memories.

Referring back to FIG. 7, the synchronization packet N with a cycle T has a high priority and thus is allocated to a first packet memory of each of the time slots so that it may be transmitted before the other packets. The general data packets A and B received at the same time are respectively stored in second and third packet memories of a first time slot according to their priority. Then the lastly received data packets A and C are assigned to second and third packet memories of a next time slot. In this case, no synchronization packet is received and thus a packet memory having a high priority of the next time slot is vacant.

When the synchronization packet N is assigned to the calendar queue scheduler, an output time Tₒᵤₜ of the synchronization packet N may be maintained at a constant level by adding a predetermined time value to the time when this packet was received. The calendar queue scheduler outputs packets corresponding to the output time Tₒᵤₜ at the output time Tₒᵤₜ by using information regarding the output port. FIG. 9 illustrates a process of outputting the synchronization packet N.

In conclusion, the synchronization packet N input at regular time intervals may be retained in bridges for a predetermined time and is guaranteed to be output at regular time intervals by adding the predetermined time value to time when it is received.

A conventional bridge uses work conserving policies, and thus, if there are packets to be serviced, scheduling thereof is necessary. Thus a bandwidth may be efficiently used but it is difficult to output the packets at regular time intervals by reducing jitter between packets and a deviation of time delays.

On the other hand, a bridge using a scheduling method according to an embodiment of the present invention applies a calendar queue scheduler that uses non-work conserving policies to process a synchronization packet and general data packet. Even if there are packets to be serviced, schedulers using the non-work conserving policies schedule only qualified packets from among them. Accordingly, it is possible to adjust the time when the synchronization packet is to be transmitted, and thus, the synchronization packet may be output at regular time intervals by reducing jitter between packets and a deviation of time delays.

The present invention can be embodied as computer readable code in a computer readable recording medium. Here, the computer readable recording medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable recording medium may be a carrier wave that transmits data via the Internet, for example. The computer readable recording medium can be distributed among computer systems that are interconnected through a network, and the present invention may be stored and implemented as computer readable code in the distributed system.

As described above, according to the above embodiments of the present invention, the time synchronization precision can be improved by maintaining time delays of a synchronization packet at a constant level in respective bridges interposed between a master and a slave. That is, times needed to process the synchronization packet in the respective bridges between the master and the slave are maintained at a constant level so as to reduce jitter and a deviation of time delays, thereby increasing the precision of time synchronization. Also, the periodicity of the synchronization packet that the master periodically transmits is maintained even until this packet is transmitted to the slave while passing through the bridges, thereby increasing the time synchronization precision.

While this invention has been particularly shown and described with reference to exemplary embodiments thereof, it will be understood by those of ordinary skill in the art that various changes in form and details may be made therein without departing from the spirit and scope of the invention as defined by the appended claims.

1. A time synchronization method performed in at least one bridge interposed between a master and a slave, the method comprising:
setting an output time of a synchronization packet to a predetermined time after the synchronization packet is received; and
outputting the synchronization packet at the set output time.

2. The method of claim 1, further comprising categorizing packets into synchronization packets and general data packets.

3. The method of claim 1, wherein the setting of the output time of the synchronization packet comprises:
calculating the difference between receipt times when two sequential synchronization packets are respectively received;
calculating the difference between packet output times specified in the two respective synchronization packets;
calculating a frequency transformation value by dividing the difference between the receipt times by the difference between the packet output times;
calculating a time delay by multiplying the frequency transformation value by a cycle of a bridge clock output from the bridge; and
setting output times of the synchronization packets by respectively adding the time delay to the receipt times when these packets are received.

4. The method of claim 1, wherein the outputting of the synchronization packet comprises outputting the synchronization packet containing a time value of the output time.

5. A time synchronization method performed in at least one bridge interposed between a master and a slave, the method comprising:
categorizing received packets into a synchronization packet and general data packets;
storing the synchronization packet in a high-priority region of a time slot corresponding to a receipt cycle of the synchronization packet from among time slots of a scheduler;
setting an output time of the synchronization packet to a predetermined time after the synchronization packet is received; and
outputting the synchronization packet stored in the corresponding time slot of the scheduler, at the set output time.

6. The method of claim 5, wherein the storing of the synchronization packet comprises storing the synchronization packet in a high-priority packet memory of the scheduler which includes a predetermined number of time slots, each of which has the high-priority packet memory and other packet memories.

7. The method of claim 5, wherein the setting of the output time of the synchronization packet comprises setting the output time of the synchronization packet to a predetermined time after the synchronization packet stored in the scheduler is received, in order to allow the synchronization packet to be received and output at the same time intervals.

8. The method of claim 5, wherein the setting of the output time of the synchronization packet comprises setting the output time of the synchronization packet by dividing the difference between times when two sequential synchronization packets are respectively received by the difference between output time values contained in the two respective synchronization packets and then multiplying the dividing result by a cycle of a clock signal output from the bridge.

9. The method of claim 5, wherein the outputting of the synchronization packet comprises outputting the synchronization packet containing an output time value.

10. A bridge located between a master and a slave to perform time synchronization, the bridge comprising:
a packet categorizing unit categorizing received packets into a synchronization packet and general data packets;
a switching unit storing the synchronization packet in a high-priority region of a time slot corresponding to a receipt cycle of the synchronization packet from among time slots of a scheduler;
a synchronization unit setting an output time of the synchronization packet to a predetermined time after the synchronization packet is received; and
a scheduler outputting the synchronization packet stored in the corresponding time slot of the scheduler, at the set output time.

11. The bridge of claim 10, wherein the switching unit stores the synchronization packet in a high-priority packet memory of the scheduler which includes a predetermined number of time slots, each of which have the high-priority packet memory and other packet memories.

12. The bridge of claim 10, wherein the synchronization unit comprises setting the output time of the synchronization packet to a predetermined time after the synchronization packet stored in the scheduler is received, in order to allow the synchronization packet to be received and output at the same time intervals.

13. The bridge of claim 10, wherein the synchronization unit comprises setting the output time of the synchronization packet by dividing the difference between times when two sequential synchronization packets are respectively received by the difference between output time values contained in the two respective synchronization packets and then multiplying the dividing result by a cycle of a clock signal output from the bridge.

14. The bridge of claim 10, wherein the scheduler comprises outputting the synchronization packet containing an output time value.

15. A computer readable recording medium having recorded thereon a program for executing the method of claim 1.
